(19) United States
(12) Patent Application Publication
(10) Pub. No.: US 2024/0397854 A1
(43) Pub. Date: Dec. 5, 2024

(54) SYSTEM OF DETECTING AND POSITION SEED FOR PLANTING

(71) Applicant: GARY W. CLEM, INC., Nevada, IA (US)

(72) Inventors: Robert Franklin Paul, Johnston, IA (US); Cody James Sobotka, Colo, IA (US); Cody James Ramsey, Bondurant, IA (US)

(21) Appl. No.: 18/733,345

(22) Filed: Jun. 4, 2024

Related U.S. Application Data
(60) Provisional application No. 63/506,237, filed on Jun. 5, 2023.

(51) Int. Cl. A01C 7/12; A01C 7/10; A01C 7/20

(52) U.S. Cl. CPC A01C 7/12; A01C 7/105; A01C 7/20

(57) ABSTRACT

A seed planting and detection system has a seed meter with a seed disc having a plurality of spaced apertures positioned about and adjacent an outer edge of the seed disc. A seed pickup is positioned about the outer edge of the seed disc where a seed is placed into one of the plurality of spaced apertures. Positioned downstream from the seed pickup area is a singulator that is configured to knock extra seeds off of the seed disc. Downstream from the singulator is a release point configured to release the seed placed into the one of the plurality of spaced apertures for delivery to a targeted area.

### CROSS REFERENCE TO RELATED APPLICATION

This application claims the benefit of U.S. Provisional Application Ser. No. 63/506,237 filed Jun. 5, 2023, the contents of these applications are hereby incorporated by reference in their entirety.

### BACKGROUND OF THE INVENTION

The present invention is directed to a system of detecting and positioning seed for planting and more particularly for controlling the release of seed from a seed plate to be delivered to a target position.

Breeders desire testing genetics of seed on an equal playing field by reducing as many variables as possible. One way of doing this is through the consistent alignment of the first and last planted seeds of adjacent rows which minimizes or eliminates border effect. Border effect includes the yield loss or gain of plants near alleys that do not receive equal light exposure. Also desirable is to adjust the position of the seeds planted immediately before the last seed and/or after the first seed to provide consistent spacing. Another method of reducing variables is through the minimization or elimination of yield loss associated with skips, runts, untreated, split, or otherwise rejected seed.

In addition, desired is a more reliable count of planted seed and data to calculate yield per plant and/or conduct germination studies. Presently there are challenges with gravity drop seed tube sensors as they have accuracy limitations of +/−1% in ideal conditions and tend to be unstable in adverse conditions. There is also a desire to allow the planting of plots having differing lengths simultaneously. In addition to optimizing alignment of the first and last seeds of a planted group row it is also desirable to align/synchronize seeds within the planted group row.

These deficiencies are overcome, particularly on a research planter, by sensing the location and presence of a singulated seed within the seed meter, as well as possibly within a seed transport mechanism and using motion control to deliver the seed to the ground in the most accurate way possible. Ideally, the system detects and optimizes the position of the first seed, the last seed, or any seed and is used with any grain type.

These and other aspects, features, and advantages of the invention will become apparent from the specification and claims.

An objective of the invention is to provide a seed planting and detection system that aligns the first and last planted seeds of adjacent rows to reduce or eliminate border effect.

Another objective of the invention is to provide a seed planting and detection system that adjusts the position of seeds planted immediately before the last seed and/or after the first seed to provide consistent spacing.

A still further objective is to provide a seed planting and detection system that provides a more reliable count of planted seed and data to calculate yield per plant and/or conduct germination studies.

These and other objectives will be apparent to those skilled in the art based on the following written description, drawings and claims.

### SUMMARY OF THE INVENTION

A seed planting and detection system includes a seed meter having a seed disc with a plurality of spaced apertures positioned about and adjacent an outer edge of the seed disc. A seed pickup is positioned about the outer edge of the seed disc where a seed is placed into one of the plurality of spaced apertures. A singulator is positioned downstream from the seed pickup area and configured to knock off extra seeds from the seed disc. A release point is downstream from the singulator and is configured to release the seed placed into the one of the plurality of spaced apertures for delivery to a targeted area.

A sensor is positioned between the singulator and the release point and configured to detect a presence of the seed placed into one of the plurality of spaced apertures. The sensor is configured to detect a presence of the seed placed into one of the plurality of spaced apertures. The sensor is calibrated to produce an output signal for a certain sized object and produces no signal for objects smaller than the certain sized object. Further, the sensor is positioned upstream from the release point to permit time for a controller to change a position of the detected seed relative to the release point.

Alternatively, the seed disc has a first and a second series of apertures that are indexed symmetrically about a center of the seed disc. A first sensor is placed over the first series of apertures and a second sensor is placed over the second series of apertures. The first sensor produces a signal when no seed is detected in the first series of apertures and produces an alternative signal when the aperture is blocked. The second sensor produces a signal when an open aperture is detected. A controller, upon receiving signals from the first and second sensors, determines whether there is a seed present on the seed disc when the second sensor detects an open aperture and the first sensor detects a blocked aperture.

### BRIEF DESCRIPTION OF THE DRAWINGS

FIG. 1 is a top plan view of seeds positioned in a field;

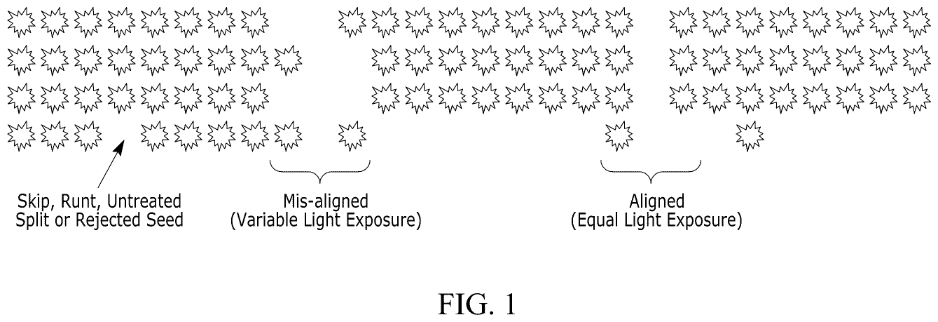

FIG. 2 is a side view of a seed disc for a seed planting and detection system, and

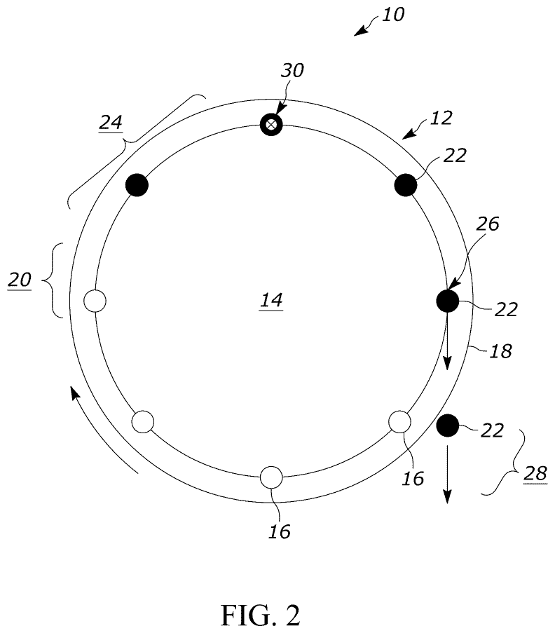

FIG. 3 is a side view of a seed disc for a seed planting and detection system.

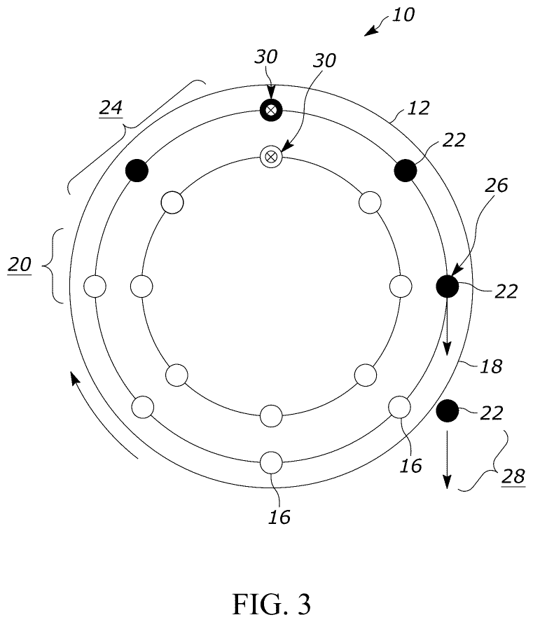

### DETAILED DESCRIPTION

A seed planting and detection system 10 includes a seed meter 12 having a seed disc 14 with a plurality of spaced apertures 16 positioned about and adjacent an outer edge 18 of the seed disc 14. Positioned about the outer edge 18 of the seed disc 14 is a seed pickup area 20 where seed 22 is received from a seed hopper (not shown) into an aperture 16. Downstream from the seed pickup area 20 is a singulator 24 where extra seeds 22 are knocked off of the seed disc 14. Also, downstream from the singulator 24 is a release point 26 where seed 22 is released from the seed disc 14 for delivery to a targeted area 28.

Positioned between the singulator 24 and the release point 26 is a sensor 30 used to detect the presence of a seed 22 on the seed disc 14. The seed sensor 30 is of any type and in one example is of a reflective type that detects an object that protrudes off a calibrated surface a certain distance. The sensor 30 is calibrated to produce an output signal for a certain sized object and let smaller objects pass without producing a signal. Other types of sensors or combination of sensors can be used such as background suppression, through beam, fiber optic, diffuse, optical, ultrasonic, vision, and the like.

The sensor 30 is positioned sufficiently downstream of the seed pickup area 20 and the singulator 24 to provide time to detect the first seed 22 of a group picked up by the seed disc 14, the last seed 22 of a group picked up by the seed disc 14, and any seed picked up by the seed disc 14 in between. The seed sensor is positioned sufficiently upstream from the seed release point 26 to allow time for a controller 32 to correct the position of the detected seed 22 on the seed disc 14 relative to the release point 26.

Alternatively, the seed disc 14 has a first 34 and a second 36 series of apertures 16 that are indexed symmetrically about the center 38 of the disc 14 or, if compensated for, alternatively. Two sensors 30 are used with one placed over the first series 34 of apertures 16 and the second sensor 30 placed over the second series 36 of apertures. The first sensor 30 produces a signal when an open aperture (no seed present) is detected and produces an alternate signal when no open hole is detected (hold blocked or no hole present). The second sensor 30 produces a signal when an open hole is detected. If the second sensor 30 detects and open hole and the first sensor 30 does not then the controller 32 determines that a seed is present. The alternative method of using two sensors 30 is potentially more reliable in detecting the presence of small seeds and less likely to falsely detect disc 14 features. To use, in one example, a calibration check is performed to ensure that all holes are open and the sensors are functioning properly.

The controller 32 uses disc 14 geometry (distance from seed aperture 16 to disc center) and angular rotation of disc 14 to determine the position of the seed 22 relative to the release point 24. In this manner the need to use a motor shaft encoder and motor gearbox ratio from a motor directly coupled to the seed disc to monitor motor output shaft rotation to determine disc rotation is eliminated.

Various sensor data and system parameters can be used to calculate, in real time, the optimal release time of any seed in a planted group. For example, the controller monitors disc rotation 14 after the seed 22 is detected by determining the distance of the seed 22 from the target seed placement location using GPS data, the offset between the GPS sensor and seed delivery tube or ground speed sensor, a timer, and a reference location. Other factors that influence seed location are also used such as the horizontal distance the seed travels from the time the seed is released from the seed transport mechanism and comes to rest in the seed trench. Additional factors used include planter ground speed, seed tube geometry (height of drop point to ground and tube curvature) seed initial velocity at release point, seed aerodynamic drag, seed size/shape/density, coefficient of restitution factors, seed coefficient of friction against seed tube, seed exit trajectory, roll in the seed trench, and the like.

Sensor feedback downstream of the release point can also be used by the controller to determine seed position after leaving the release point. Examples include assisted delivery, seed tube seed sensor, trench seed sensor, ground speed monitoring and compensation, plate speed compensation and the like.

In operation, particularly in seed research planting, it is desirable that the first seed planted in a group (i.e. plot) and the last seed planted in a group be planted at a target location. This ensures that the start of planting boundaries are aligned row to row and pass to pass. Alignment has agronomic value and better enables activities that take place in the field after planting such as scouting, spraying, harvesting, and the like. Traditional methods use a time seed release based on an assumed seed presence (location of disc aperture relative to a timing feature) which results in several inches of first and last seed placement error when one or more apertures at the start or end of a new group do not pick up because there is no means to correct for an open aperture. To correct for this, after detecting the presence of the first and last seed in a group the controller increases or decreases the rotational speed of the seed disc as needed to bring the detected seed to the release point at the target time.

Also desirable is for seeds planted between the first and last in a group have optimal spacing and an appropriate number of seed in each plot. This provides value as produced is more representative and consistent data on which high value research decisions are made. To accomplish this the controller compensates for skips (open apertures) and rejected undesirable seeds by increasing or decreasing the rotational speed of the seed disc as needed to bring the detected seed to the release point at the target time.

From the above discussion and accompanying figures and claims it will be appreciated that the tool storage assembly 10 offers many advantages over the prior art. Although the present disclosure and its advantages have been described in detail, it should be understood that various changes, substitutions, modifications, and alterations can be made herein without departing from the technology of the disclosure as defined by the appended claims. The scope of the present application is not intended to be limited to the particular configurations of the process, machine, manufacture, composition of matter, means, methods and steps described in the specification only expressly stated otherwise. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A seed planting and detection system, comprising:
a seed meter having a seed disc with a plurality of spaced apertures positioned about and adjacent an outer edge of the seed disc;
a seed pickup area positioned about the outer edge of the seed disc where a seed is placed into one of the plurality of spaced apertures;
a singulator positioned downstream from the seed pickup area and configured to knock off extra seeds from the seed disc; and
a release point downstream from the singulator configured to release the seed placed into the one of the plurality of spaced apertures for delivery to a targeted area.

2. The system of claim 1 wherein a sensor is positioned between the singulator and the release point and configured to detect a presence of the seed placed into one of the plurality of spaced apertures.

3. The system of claim 2 wherein the sensor is a reflective type configured to detect an object that protrudes off a calibrated surface a certain distance.

4. The system of claim 2 wherein the sensor is calibrated to produce an output signal for a certain sized object and produces no signal for objects smaller than the certain sized object.

5. The system of claim 2 wherein the sensor is positioned upstream from the release point to permit time for a controller to change a position of the detected seed relative to the release point.

6. A seed planting and detection system, comprising:
a seed meter having a seed disc with a first and a second series of apertures that are indexed symmetrically about a center of the seed disc;
a seed pickup area positioned about the outer edge of the seed disc where a seed is placed into one of the indexed apertures;
a singulator positioned downstream from the seed pickup area and configured to knock off extra seeds from the seed disc; and
a release point downstream from the singulator configured to release the seed placed into the one of the plurality of spaced apertures for delivery to a targeted area.

7. The system of claim 6 further comprising a first sensor placed over the first series of apertures and a second sensor placed over the second series of apertures.

8. The system of claim 7 wherein the first sensor produces a signal when no seed is detected in the first series of apertures and produces an alternative signal when the aperture is blocked.

9. The system of claim 7 wherein the second sensor produces a signal when an open aperture is detected.

10. The system of claim 6 wherein a controller determines that the seed is present on the seed disc when the second sensor detects an open aperture, and the first sensor detects a blocked aperture.
